(19) United States
(12) Patent Application Publication
(10) Pub. No.: US 2023/0286101 A1
(43) Pub. Date: Sep. 14, 2023

(54) RAZOR CARTRIDGE REFURBISHMENT

(71) Applicant: Planet Earth Razors AB, Stockholm (SE)

(72) Inventors: Mats DANIELSSON, Täby (SE); Sam HACOHEN, Haifa (IL); Shlomo ZUCKER, Mikhmoret (IL)

(73) Assignee: Planet Earth Razors AB, Stockholm (SE)

(21) Appl. No.: 17/689,795

(22) Filed: Mar. 8, 2022

(51) Int. Cl. B24B 3/48; A45D 27/46; B26B 21/22

(52) U.S. Cl. CPC B24B 3/48; A45D 27/46; B26B 21/222

(57) ABSTRACT

A method for refurbishment of razor cartridges (10) comprises determining an identity of a consumer based on a consumer identifier associated with a razor cartridge (10) comprising at least one razor blade (20, 22, 24) and received from the consumer. The at least one razor blade is cleaned and at least a portion of the at least one razor blade is re-coated. A quality of the razor cartridge (10) following cleaning and re-coating is verified prior to packaging the razor cartridge (10) for delivery to the consumer. The delivery address for the packaged razor cartridge (10) is determined based on the identity of the consumer as determined based on the consumer identifier associated with the razor cartridge (10).

### TECHNICAL FIELD

The present invention generally relates to razor cartridges, and in particular to a method and system for refurbishment of razor cartridges.

### BACKGROUND

There is a general trend of recycling or reusing consumer products to reduce waste from the consumer products and emission of greenhouse gases in connection with production. One area where this is particularly interesting is within personal grooming care. Most men, and many women, shave parts of their facial and/or body hair on a regular basis. While some consumers use electric razors or entirely disposable ones, the majority of consumers use refill cartridge razors, i.e., a reusable handle that is fitted with a new razor cartridge when the previous one is worn out.

The razor cartridge generally consists of plastic polymer and rubber components in addition to the stainless steel razors. The razor cartridges may be, depending on the design of the razor cartridges, very hard to dismantle into individual components by the consumers. It is therefore very hard to recycle the different materials of the razor cartridges in an efficient way. As a consequence, in the best scenario, the used razor cartridges end up in waste facilities for energy production or are used as landfills. The everyday consumption of razor cartridges thereby leads to large emissions during the entire chain from material sourcing, production, transportation and up to disposal.

Various techniques have been proposed to prolong the service life of razor cartridges including cleaning as disclosed in CA Patent Publication No. 2261320, U.S. Pat. Nos. 4,480,387, 4,937,940, 5,365,958, 6,886,211, 7,263,738, 10,722,018 and U.S. Patent Publication Nos. 2002/0145058, 2008/0006311, 2006/0283487, 2018/0192757 and re-sharpening as disclosed in U.S. Pat. Nos. 6,506,106, 6,969,299, 7,104,874 and U.S. Patent Publication Nos. 2005/0101231, 2009/0000426. These prior art solutions, however, require the consumer to have a dedicated cleaning apparatus and a dedicated re-sharpening apparatus and to handle these operations by themselves.

There is therefore a need for a more efficient and user friendly management of razor cartridges.

### SUMMARY

It is a general objective of the invention to provide a method and system for refurbishment of razor cartridges.

This and other objectives are met by the embodiments as disclosed herein.

An aspect of the invention relates to a method for refurbishment of razor cartridges. The method comprises determining an identity of a consumer based on a consumer identifier associated with a razor cartridge comprising at least one razor blade and received from the consumer. The method also comprises cleaning the at least one razor blade and re-coating at least a portion of the at least one razor blade. The method further comprises verifying a quality of the razor cartridge following cleaning and re-coating. The method additionally comprises packaging the razor cartridge for delivery to the consumer and determining a delivery address for the packaged razor cartridge based on the identity of the consumer as determined based on the consumer identifier associated with the razor cartridge.

Another aspect of the invention relates to system for refurbishment of razor cartridges. The system comprises an identifier reader configured to read an identifier associated with a razor cartridge comprising at least one razor blade and received from the consumer. The system also comprises a cleaning device configured to clean the at least one razor blade and a re-coating device configured re-coat at least a portion of the at least one razor blade. The system further comprises at least one processor and at least one memory coupled to the at least one processor and the identifier reader. The memory stores program instructions executable by the at least one processor to determine an identity of a consumer from which the razor cartridge is received based on a consumer identifier as read by the identifier reader or as retrieved from the at least one memory based on the identifier read by the identifier reader and determine a delivery address for the razor cartridge packaged for delivery to the consumer based on the identity of the consumer.

The method and system of the invention provide a refurbishment service to consumers to enable refurbishment and thereby re-use of worn out razor cartridges. The method and system achieve such a refurbishment while tracking razor cartridges to enable return of the razor cartridges to the correct consumer.

### BRIEF DESCRIPTION OF THE DRAWINGS

The embodiments, together with further objects and advantages thereof, may best be understood by making reference to the following description taken together with the accompanying drawings, in which:

FIG. 1 is a schematic illustration of a method for refurbishment of razor cartridges according to an embodiment;

FIG. 2 schematically illustrates an example of a refill cartridge razor;

FIG. 3 schematically illustrates a razor cartridge according to an embodiment;

FIG. 4 schematically illustrates a dissembled razor cartridge;

FIGS. 5A and 5B schematically illustrate a dispenser with razor cartridges according to an embodiment in a front view (A) and in a side view (B); and

FIG. 6 is a schematic overview of a system for refurbishment of razor cartridges according to an embodiment.

### DETAILED DESCRIPTION

The present invention generally relates to razor cartridges, and in particular to a method and system for refurbishment of razor cartridges.

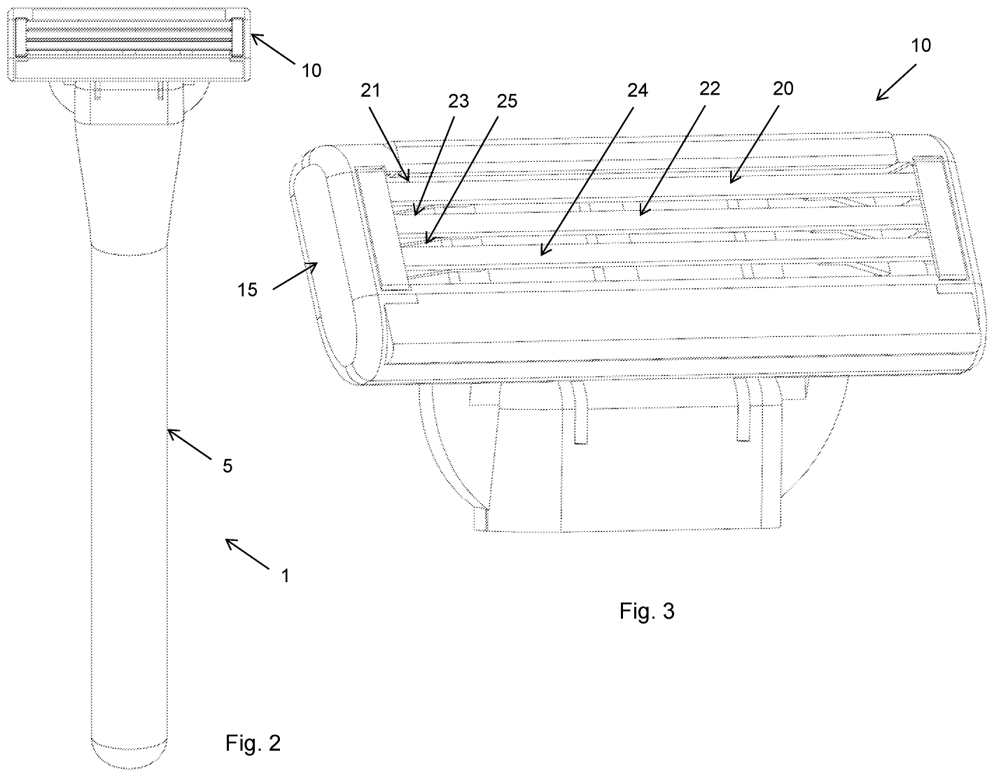

Razors are used by a large portion of the adult population, both men and women, for personal grooming care. Razors come in two main versions, electric razors and non-electric razors. The latter ones could be entirely disposable but the majority of these razors are so-called refill cartridge razors as schematically shown in FIG. 2. Such a refill cartridge razor 1 basically consists of a reusable handle 5 that is fitted with a new razor cartridge 10 when the old one is worn out.

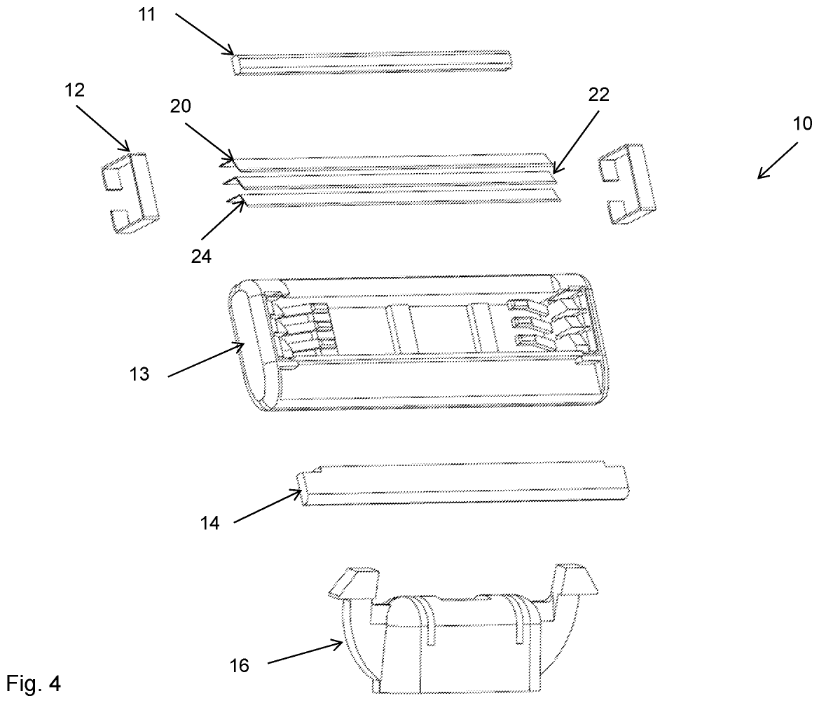

Although such refill cartridge razors 1 are generally more environmentally friendly as compared to disposable razors in the long run due to the re-use of the handle 5 and thereby merely exchanging razor cartridges 10, they still have an impact on the environment since they are hard to recycle or dispose in an environmentally friendly way. The reason for this is that the razor cartridge 10 consists of different parts made of different materials as schematically shown in FIG. 4. Generally, a razor cartridge comprises a plastic cartridge housing, body or base 13, one or more razor blades 20, 22, 24 typically made of stainless steel, a retention spring 12 for the razor blades 20, 22, 24, which is often in metal, a rubber strip 14, a hydration strip 11 and a plastic cartridge holder 16 that attaches the razor cartridge 10 to the re-usable handle 5. The various materials of the components of the razor cartridge 10 make it very had, if not impossible, to disable and recycle the razor cartridge 10 after usage for the consumer. In the best scenario, the used razor cartridge ends up in facilities for waste to energy management or directly transferred to landfills.

The components of the razor cartridge 10 are most often not worn out once the consumer disposes the razor cartridge 10. Hence, the razor cartridge 10 could be re-used if refurbished. As mentioned in the background section, various techniques have been proposed to prolong the service life of razor cartridges 10 including cleaning and re-sharpening. These prior art solutions, however, require the consumers to have a dedicated cleaning apparatus and a dedicated re-sharpening apparatus and to handle these operations by themselves.

The present invention solves these shortcomings with the prior art by providing a method and a system for refurbishment of razor cartridges 10. The present invention thereby enables a user or consumer to send his or her razor cartridge 10 once worn out to a refurbishment service provider, which performs the refurbishment method to provide a refurbished version of the razor cartridge 10. This refurbished version of the razor cartridge 10 is then returned to the original consumer. A significant advantage of the present invention is that the razor cartridge 10 as received from a consumer is tracked during the refurbishment process to enable return of the razor cartridge 10 once refurbished to the original consumer. This means that consumers will only receive their own razor cartridges 10 and the risk of unintentionally returning a razor cartridge 10 received from a given consumer to another consumer is thereby reduced. The method and system of the invention will thereby safeguard that the consumers get their own razor cartridges 10 and razor blades 20, 22, 24 as sent to the refurbishment service provider.

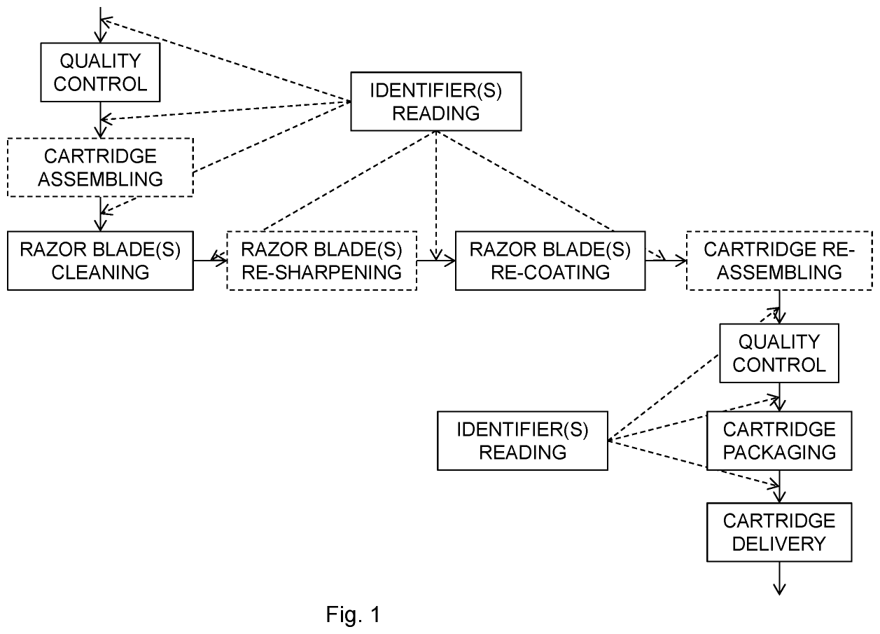

With reference to FIGS. 1 to 5, an aspect of the invention relates to a method for refurbishment of razor cartridges 10. The method comprises determining an identity of a consumer based on a consumer identifier associated with a razor cartridge 10 comprising at least one razor blade 20, 22, 24 and received from the consumer. The method also comprises cleaning the at least one razor blade 20, 22, 24 and re-coating at least a portion of the at least one razor blade 20, 22, 24. The method further comprises verifying a quality of the razor cartridge 10 following cleaning and re-coating. The method additionally comprises packing the razor cartridge 10 for delivery to the consumer and determining a delivery address for the packaged razor cartridge 10 based on the identity of the consumer as determined based on the consumer identifier associated with the razor cartridge 10.

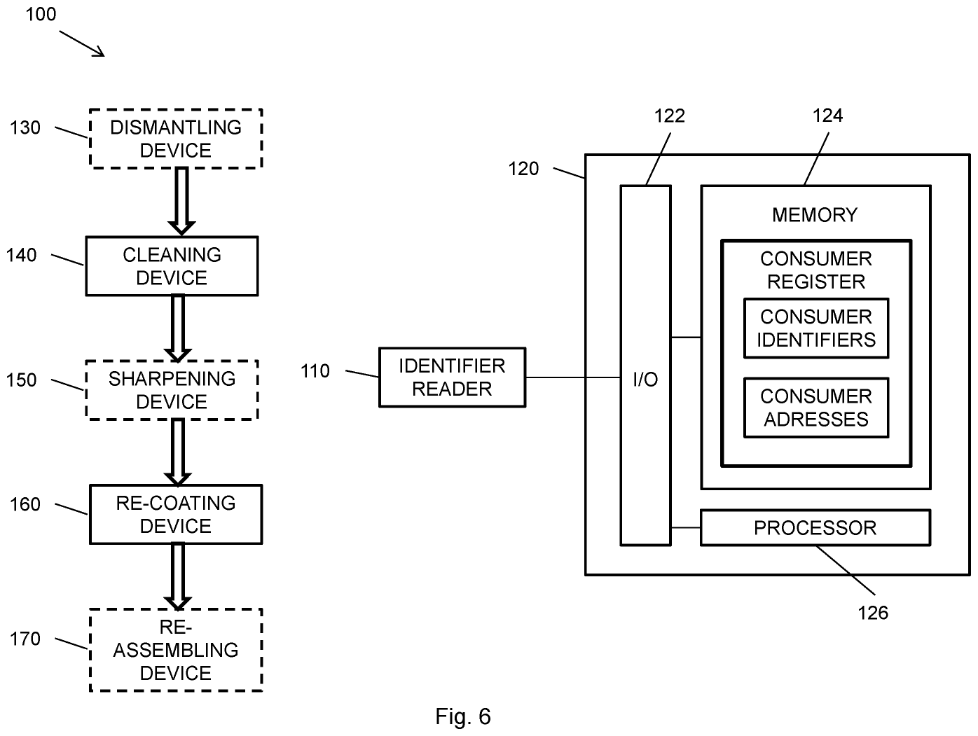

The above mentioned and in FIG. 1 presented method is preferably conducted by a refurbishment service provider. The service provider then has access to a consumer register, see FIG. 6, of existing consumers that use the refurbishment services provided by the service provider. Once a consumer sends his/her used razor cartridge or razor cartridges 10 to the service provider, the identity of the consumer is determined based on a consumer identifier associated with the received razor cartridge(s) 10. This identity determination enables the service provider to determine from which particular consumer the razor cartridge(s) 10 originate. The identity of the consumer is determined based on the consumer identifier associated with the razor cartridge(s) 10.

The association between the consumer identifier and a razor cartridge 10 could be implemented according to various embodiments.

In an embodiment, the razor cartridge 10 comprises the consumer identifier 15 provided on the razor cartridge 10 as schematically shown in FIG. 3. For instance, the consumer identifier 15 could be provided on the cartridge base 13 of the razor cartridge 10 as shown in FIG. 3. In such an embodiment, the consumer identifier 15 could be read once the razor cartridge 10 is received from the consumer and/or during any step in the refurbishment method as indicated in FIG. 1.

In another embodiment, the razor cartridge 10 comprises a cartridge identifier 15. For instance, the cartridge identifier 15 could be provided on the cartridge base 13 of the razor cartridge 10. In such a case, the consumer register of the service provider comprises information of the cartridge identifier or identifiers associated with a given consumer and thereby of its consumer identifier. Such information could list the cartridge identifiers 15 of the different razor cartridges 10 belonging to a given consumer having an assigned consumer identifier, such as 564799: 184966, 184967, 342789, where 564799 represents the consumer identifier and 184966, 184967 and 342789 are three different cartridge identifiers 15 each provided in a respective razor cartridge 10 of the consumer. Another example would be to have the association between a consumer identifier and cartridge identifiers in the form of having cartridge identifiers consisting of the consumer identifier and a separate cartridge id, such as 564799-01, 564799-02 and 564799-03 as cartridge identifiers for three different razor cartridges 10 of a consumer with assigned consumer identifier of 564799. In such an embodiment, the cartridge identifier could be read once received from the consumer and/or during any step in the refurbishment method as indicated in FIG. 1. The consumer identifier is then identified or determined, such as from the consumer register, based on the read cartridge identifier 15.

In a further embodiment, the consumer identifier 21, 23, 25 could be provided on at least one razor blade 20, 22, 24 of the razor cartridge 10. For instance, each razor blade 20, 22, 24 could comprise the consumer identifier 21, 23, 25 as shown in FIG. 3 if the razor cartridge 10 comprises multiple, i.e., at least two, razor blades 20, 22, 24. Alternatively, the consumer identifier 21, 23, 25 could be provided on a subset or one of the razor blades 20, 22, 24. In such an embodiment, the consumer identifier 21, 23, 25 could be read once received from the consumer and/or during any step in the refurbishment method as indicated in FIG. 1.

In yet another embodiment, each razor blade 20, 22, 24 of the razor cartridge 10 comprises a respective blade identifier 21, 23, 25. In such a case, the consumer register of the service provider comprises information of the blade identifiers 21, 23, 25 associated with a given consumer and thereby of its consumer identifier. Such information could list the blade identifiers 21, 23, 25 of any razor cartridges 10 belonging to a given consumer having an assigned consumer identifier, such as 564799: 184966, 184967, 342789, where 564799 represents the consumer identifier and 184966, 184967 and 342789 are three different blade identifiers 21, 23, 25, each provided on a respective razor blade 20, 22, 24 in one or more razor cartridges 10 of the consumer. Another example would be to have the association between a consumer identifier and blade identifiers in the form of having blade identifiers consisting of the consumer identifier and a separate blade id, such as 564799-01, 564799-02 and 564799-03 as blade identifiers for three different razor blades 20, 22, 24 of a consumer with assigned consumer identifier of 564799. In such an embodiment, one or more razor identifiers 21, 23, 25 could be read once a razor cartridge 10 is received from the consumer and/or during any step in the refurbishment method as indicated in FIG. 1. The consumer identifier is then identified or determined, such as from the consumer register, based on the read blade identifier(s) 21, 23, 25.

The association between blade identifiers and consumer identifiers could, alternatively, be provided through cartridge identifiers. In such a case, the razor cartridges 10 of a consumer with an assigned consumer identifier have a respective cartridge identifier 15. Furthermore, the at least one razor blade 20, 22, 24 in the razor cartridges 10 has a respective blade identifier or all razor blades 20, 22, 24 in a given razor cartridge 10 could have the same blade identifier 21, 23, 25. In such an approach, the cartridge identifier 15 and/or the blade identifier(s) 21, 23, 25 could be read once a razor cartridge 10 is received from the consumer and/or during any step in the refurbishment method as indicated in FIG. 1. The consumer register then preferably comprises information of the various blade identifiers 21, 23, 25 and cartridge identifiers 15 for a given consumer with assigned a consumer identifier. An example of a combined identifier system could be to use nnnnnn-mm-pp, such as 564799-01-02, wherein nnnnnn (564799) represents the consumer identifier, mm (01) represents the cartridge number for a razor cartridge and pp (02) represents the blade number for razor cartridge number mm (01).

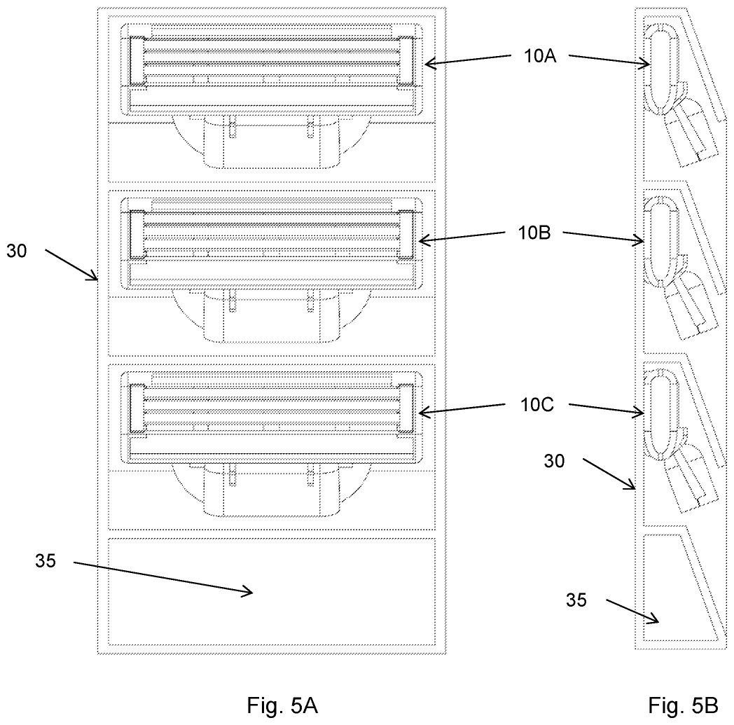

In a further embodiment, razor cartridges 10A, 10B, 10C are provided in a cartridge dispenser or simply dispenser 30 comprising one or, preferably, multiple razor cartridges 10A, 10B, 10C, see FIGS. 5A and 5B. In such a case, the dispenser 30 could comprise the consumer identifier 35 anywhere on the dispenser housing or body. In such an embodiment, the consumer identifier 35 could be read once the dispenser 30 is received from the consumer and/or during any step in the refurbishment method as indicated in FIG. 1.

In another embodiment, the dispenser 30 comprises a dispenser identifier 35. For instance, the dispenser identifier 35 could be provided on the dispenser housing or body of the dispenser 30. In such a case, the consumer register of the service provider comprises information of the dispenser identifier or identifiers associated with a given consumer and thereby of its consumer identifier. Such information could list the dispenser identifiers 35 of the different dispensers 30 belonging to a given consumer having an assigned consumer identifier similar to described above for cartridge identifiers. In such an embodiment, the dispenser identifier 35 could be read once the dispenser 30 is received from the consumer and/or during any step in the refurbishment method as indicated in FIG. 1. The consumer identifier is then identified or determined, such as from the consumer register, based on the read dispenser identifier 35.

Any type of identifier could be used for the consumer identifier, the cartridge identifier, the blade identifier and dispenser identifier as long as the identifier could be associated with and enabling identification of a consumer, razor cartridge 10, razor blade 20, 22, 24 or dispenser 30. Illustrative, but non-limiting, examples of such identifiers include any unique combination of letters, numbers and/or symbols, a barcode, a QR code, or other graphical pattern. In such a case, the identifier could be inscribed into the razor cartridge, razor blade and/or cartridge dispenser. Alternatively, a label containing the identifier could be attached to the razor cartridge 10, razor blade 20, 22, 24 and/or dispenser 30 such as by an adhesive.

Another type of identifier is an RFID circuit. Such a type of identifier is in particular suitable for arrangement or embedment in the dispenser 30 and/or the razor cartridges 10.

The cleaning of the razor cartridge 10 as received from a consumer is performed to remove dirt and debris, such as hair, skin and other particles, that lodges and become stuck between razor blades 20, 22, 24 of the razor cartridge 10 and/or between a razor blade 20, 22, 24 and the cartridge base 13.

The cleaning of the razor cartridges can be performed according to well-known techniques, such as disclosed in any of CA Patent Publication No. 2261320, U.S. Pat. Nos. 4,480,387, 4,937,940, 5,365,958, 6,886,211, 7,263,738, 10,722,018 and U.S. Patent Publication Nos. 2002/0145058, 2008/0006311, 2006/0283487, 2018/0192757, the teaching of which is hereby incorporated by reference.

The cleaned razor cartridge 10 is then re-coated. In more detail, at a least a portion of the one or more razor blades 20, 22, 24 is re-coated. The re-coat could be provided on the complete razor blade 20, 22, 24 or merely a portion thereof. In particular, the cutting edge of the razor blade 20, 22, 24 is preferably re-coated.

The re-coating of the razor blades can be performed according to well-known techniques for coating razor blades, and in particular coating razor blades with PTFE (TEFLON®). In an illustrative, but non-limiting, example the razor blade could be coated in a furnace plant as provided by ONEJOON. Briefly, the razor blades are preferably rep-heated to ensure the evaporation of any solvent during re-coating. Alternatively, the razor blades could be cold coated and then dried. The re-coating of the razor blades is preferably performed with a water-based PTFE. The re-coated razor blades are preferably heat treated, such as sintered, under protective gas followed by cooling under protective gas.

The coating as applied to at least a portion of the razor blade 20, 22, 24 improves the shaving effectiveness of the razor blade 20, 22, 24. In particular, the coating decreases the pull to cut hair, i.e., decreases the force required to cut the hair, and thereby improves the ease and smoothness of shaving. Hair proteins, in particular keratin, tend to adhere to the material of the razor blade 20, 22, 24, such as stainless steel, if uncoated. This causes a pulling at the hair follicle during shaving. The coating reduces this adherence between razor blade 20, 22, 24 and the hair proteins.

In a particular embodiment, the at least a portion of the at least one razor blade 20, 22, 24 is re-coated with a polytetraluoroethylene (PTFE) coating.

The refurbishment method of the invention also comprises a quality control prior to delivering the cleaned and re-coated razor cartridge 10 to the consumer. This quality control verifies that quality of the razor cartridge 10 following cleaning and re-coating is sufficient for delivery to the consumer. The quality control is preferably a visual inspection of the razor cartridge 10 to verify that the cleaning and re-coating has been sufficiently and correctly performed before packaging the razor cartridge 10 for delivery to the consumer. If the quality control detects that the quality of the refurbished razor cartridge 10 is not sufficient the razor cartridge 10 may be subject to one or more additional cleaning and/or re-coating operations until the quality is deemed to be sufficient for delivery to the consumer. Alternatively, the razor cartridge 10 could be deemed to be unsuitable for refurbishment and is thereby discarded and replaced by a new razor cartridge 10. This new razor cartridge 10 is then associated with the consumer identifier of the consumer.

As briefly described in the foregoing, a dispenser 30 comprising multiple razor cartridges 10A, 10B, 10C could be received from the consumer, see FIG. 5. In such a case, the method preferably comprises verifying that the multiple razor cartridges 10 are associated with the same consumer identifier.

This verification of the multiple razor cartridges 10A, 10B, 10C could be performed in connection with an initial quality control as shown in FIG. 1 in connection with reception of the dispenser 30. The quality control then verifies that all of the razor cartridges 10A, 10B, 10C in the received dispenser 30 are from the same consumer, i.e., associated with the same consumer identifier. The initial verification could then detect a case where a razor cartridge not associated with the consumer identifier and thereby potentially not being a razor cartridge of the given consumer has by mistake, such as at the consumer, been added to the dispenser 30. In such a case, the detected razor cartridge is preferably removed from the dispenser 30 and replaced by a new razor cartridge that is associated with the consumer identifier of the consumer.

Alternatively, or in addition, the verification of the multiple razor cartridges 10A, 10B, 10C could be performed in connection with a quality control following cleaning and re-coating and prior to cartridge packing as shown in FIG. 1. The quality control then verifies that all of the razor cartridges 10A, 10B, 10C in the dispenser 30 to be delivered to the consumer are associated with the consumer's consumer identifier. This quality control thereby verifies that the consumer only gets his or her own razor cartridges 10A, 10B, 10C after refurbishment or a new razor cartridge replacing an old one that does not meet the quality control. If the dispenser 30 contains a razor cartridge that is not associated with consumer identifier, the razor cartridge is preferably replaced by a new razor cartridge. This new razor cartridge is then associated with the consumer identifier.

In an embodiment, each razor cartridge 10A, 10B, 10C comprises a consumer identifier 15 or a respective cartridge identifier 15 in turn associated with a consumer identifier. In such an embodiment, verifying the multiple razor cartridges 10A, 10B, 10C preferably comprises verifying that the multiple razor cartridges 10A, 10B, 10C comprises the same consumer identifier 15 or that the respective cartridge identifiers 15 of the multiple razor cartridges 10A, 10B, 10C are associated with the same consumer identifier.

Hence, the identifiers 15 of the razor cartridges 10A, 10B, 10C in the dispenser 30 are read as a part of the verification operation. If the identifiers 15 are consumer identifiers, the method verifies that the read identifiers 15 are the same for all razor cartridges 10A, 10B, 10C in the dispenser 30. If the identifiers are cartridge identifiers, the method preferably verifies that these cartridge identifiers are all associated with the same consumer identifier from the previously mentioned consumer register. Any faulty razor cartridge that has an identifier not corresponding to the consumer identifier or not being associated with consumer identifier is preferably replaced with a new razor cartridge. In such a case, this new razor cartridge is marked with consumer identifier of the relevant consumer or already comprises a cartridge identifier. In the latter case, the consumer register is updated by adding the cartridge identifier of the new razor cartridge to the other cartridge identifiers associated with the consumer identifier of the relevant consumer.

In an embodiment, the method comprises re-sharpening at least one razor blade 20, 22, 24 in the razor cartridge 10.

Hence, in this embodiment, the razor blade(s) 20, 22, 24 of the razor cartridge 10 is(are) cleaned, re-sharpened and re-coated during the refurbishment method. The re-sharpening operation preferably takes place after the cleaning operation and prior to the re-coating operation.

The re-sharpening of the razor blades can be performed according to well-known techniques, such as disclosed in any of U.S. Pat. Nos. 6,506,106, 6,969,299, 7,104,874 and U.S. Patent Publication Nos. 2005/0101231, 2009/9999426, the teaching of which is hereby incorporated by reference. Grinding machines that could be used to re-sharpen the razor blades are available from Berger Gruppe.

If the razor cartridge 10 comprises multiple razor blades 20, 22, 24 all of the razor blades 20, 22, 24 could be re-sharpened in the method. Alternatively, only a single razor blade or a subset of the razor blades 20, 22, 24 are re-sharpened. For instance, a visual inspection of the sharpness of the individual razor blades 20, 22, 24 could be performed as a part of the initial quality control to verify which razor blades 20, 22, 24, if any, of the razor cartridge 10 that needs to be re-sharpened.

In an embodiment, the initial quality control comprises verifying a quality of multiple razor cartridges 10A, 10B, 10B comprised in a dispenser 30 received from a consumer. In such an embodiment, the method also comprises replacing any razor cartridge with a new razor cartridge if the quality verification identifies the razor cartridge 10 as depleted and unsuitable for refurbishment. The method further comprises associating the razor cartridge with the consumer identifier. For instance, this new razor cartridge is marked with consumer identifier of the relevant consumer or already comprises a cartridge identifier. In the latter case, the consumer register is updated by adding the cartridge identifier of the new razor cartridge to the other cartridge identifiers associated with the consumer identifier of the relevant consumer.

In an embodiment, the method comprises dismantling the at least one razor blade 20, 22, 24 from the razor cartridge 10. In such an embodiment, the cleaning operation comprises cleaning the at least one razor blade 20, 22, 24 dismantled from the razor cartridge 10 and the re-coating operation comprises re-coating the at least a portion of the at least one razor blade 20, 22, 24 dismantled from the razor cartridge 10. The method also comprises, in this embodiment, re-assembling the at least one razor blade 20, 22, 24 onto the razor cartridge 10, or more correctly onto the cartridge base 13, or onto a new razor cartridge 10, or new cartridge base 13.

Hence, in this embodiment, the razor cartridge 10 is dismantled prior to the cleaning and re-coating operations, and the optional re-sharpening operations. It is generally easier to access the individual razor blades 20, 22, 24 and in particular their cutting edges when dismantled from the cartridge base 13. Hence, re-coating and also re-sharpening of the individual razor blades 20, 22, 24 could be performed more efficiently if the razor blades 20, 22, 24 are dismantled from the cartridge base 13. Also, a more efficient cleaning of the razor blades 20, 22, 24 and of the rest of the razor cartridge 10 may be achieved if dismantling the razor blades 20, 22, 24 from the cartridge base 13. Another advantage of dismantling the razor blades 20, 22, 24 could be when the cartridge base 13 is regarded as being depleted and unsuitable for refurbishment whereas the razor blades 20, 22, 24 could be still be refurbished. In such a case, the razor blades 20, 22, 24 could, following cleaning, optional re-sharpening and re-coating, be arranged in a new cartridge base 13.

In an embodiment, the razor cartridge 10 comprises the consumer identifier 15 or a cartridge identifier in turn associated with the consumer identifier. In this embodiment, the at least one razor blade 20, 22, 24 of the razor cartridge 10 comprises the consumer identifier 21, 23, 25 or a respective blade identifier 21, 23, 25 in turn associated with the consumer identifier. In such an embodiment, re-assembling the at least one razor blade 20, 22, 24 comprises identifying the razor cartridge 10 based on the consumer identifier 15 or cartridge identifier 15 comprised in the razor cartridge 10, identifying the at least one razor blade 20, 22, 24 based on the consumer identifier 21, 23, 25 or the respective blade identifier 21, 23, 25 comprised in the at least one razor blade 20, 22, 24 and re-assembling the at least one identified razor blade 20, 22, 24 onto the identified razor cartridge 10.

In an embodiment, identifying the at least one razor blade 20, 22, 24 comprises identifying the at least one razor blade 20, 22, 24 as comprising a) the same consumer identifier 21, 23, 25 ai) as comprised in the identified razor cartridge 10 or aii) as associated with the cartridge identifier 15 as comprised in the identified razor cartridge 10 or b) a respective blade identifier 21, 23, 25 associated with the same consumer identifier bi) as comprised in the identified razor cartridge 10 or bii) as associated with the cartridge identifier 15 as comprised in the identified razor cartridge 10.

In a particular embodiment, the at least one razor blades 20, 22, 24 and the razor cartridge 10 comprise a consumer identifier 21, 23, 25, 15. In such a case, the at least one razor blade 20, 22, 24 is identified as a razor blade 20, 22, 24 having the same consumer identifier 21, 23, 25 as the consumer identifier comprised in the razor cartridge 10.

In another particular embodiment, the at least one razor blade 20, 22, 24 comprises a consumer identifier 21, 23, 25 but the identified razor cartridge 10 comprises a cartridge identifier 15. In such a case, the cartridge identifier 15 of the identified razor cartridge 10 is used to provide the consumer identifier that is associated with the cartridge identifier 15, such as from the consumer register. This provided consumer identifier is then used to identify the at least one razor blade 20, 22, 24.

In a further particular embodiment, the at least one razor blade 20, 22, 24 comprises a respective blade identifier 21, 23, 25 associated with the same consumer identifier and the razor cartridge 10 comprises the consumer identifier 15. In such a case, consumer identifier 15 comprised in the razor cartridge 10 is used to provide any blade identifiers 21, 23, 25 associated with the consumer identifier, such as from the consumer register. The provided blade identifier(s) 21, 23, 25 is then used to identify the at least one razor blade 20, 22, 24.

In yet another particular embodiment, the at least one razor blade 20, 22, 24 comprises a respective blade identifier 21, 23, 25 associated with a consumer identifier and the razor cartridge 10 comprises a cartridge identifier 15 associated with a consumer identifier. In such a case, the cartridge identifier 15 of the identified razor cartridge 10 is used to provide the consumer identifier that is associated with the cartridge identifier 15, such as from the consumer register. The provided consumer identifier is then used to identify any blade identifiers 21, 23, 25 associated with the provided consumer identifier, such as from the consumer register. The provided blade identifier(s) 21, 23, 25 is then used to identify the at least one razor blade 20, 22, 24.

In an embodiment, re-assembling the at least one razor blade 20, 22, 24 comprises re-assembling the at least one razor blade 20, 22, 24 onto a new razor cartridge 10, or more correctly onto a new cartridge base 13. In such an embodiment, the method comprises associating the new razor cartridge 10 with the consumer identifier.

In a particular embodiment, associating the new razor cartridge 10 with the consumer identifier comprises adding the consumer identifier to the new razor cartridge. Hence, in such an embodiment, the new razor cartridge is marked with the consumer identifier.

In another particular embodiment, associating the new razor cartridge 10 with the consumer identifier comprises associating a cartridge identifier 15 comprised in the new razor cartridge 10 with the consumer identifier. For instance, the consumer register could be updated so that the cartridge identifier 15 of the new razor cartridge 10 is added to the consumer identifier.

In an embodiment, the razor cartridge 10 comprises multiple razor blades 20, 22, 24. In such an embodiment, each razor blade 20, 22, 24 of the multiple razor blades 20, 22, 24 comprises the consumer identifier 21, 23, 25 or a respective blade identifier 21, 23, 25 in turn associated with the consumer identifier.

In such an embodiment, verifying the quality comprises verifying that each razor blade 20, 22, 24 of the multiple razor blades 20, 22, 24 comprises the same consumer identifier or that the respective blade identifiers of the multiple razor blades 20, 22, 24 are associated with the same consumer identifier.

In an embodiment, the consumer register is preferably updated when any razor cartridge is discarded such as due to being unsuitable for further refurbishment. For instance, any cartridge identifier comprise in the razor cartridge is preferably removed from the listed cartridge identifiers associated with the consumer identifier of a given consumer.

As indicated in FIG. 1, an advantage of the present invention in having identifiers 15, 21, 23, 25, 35 provided on individual razor blades 20, 22, 24, on razor cartridges 10 and/or on dispensers 30 is that these components as received from consumers can be tracked through the complete refurbishment process shown in FIG. 1, which in turn safeguards the return of the razor cartridges 10 to the correct consumers. The identifiers could be read at any point during the refurbishment process, such as after each method step or operation as schematically indicated in FIG. 1. Identifier reading is performed according to well-known techniques and depending on the particular type of identifiers used, such as optically scanning identifiers in the form of combinations of letters, numbers and/or symbols, barcodes, QR codes, or other graphical patterns or interrogating RFID identifiers.

Another aspect of the invention relates to a system 100 for refurbishment of razor cartridges 10, see FIG. 6. The system 100 comprises an identifier reader 110 configured to read an identifier 15, 21, 23, 25, 35 associated with a razor cartridge 10 comprising at least one razor blade 20, 22, 24 and received from the consumer. The system 100 also comprises a cleaning device 140 configured to clean the at least one razor blade 20, 22, 24 and a re-coating device 160 configured re-coat at least a portion of the at least one razor blade 20, 22, 24. The system 100 further comprises at least one processor 126 and at least one memory 124 coupled to the at least one processor 126 and the identifier reader 110. The memory 124 stores program instructions executable by the at least one processor 126 to determine an identity of a consumer from which the razor cartridge 10 is received based on a consumer identifier as read by the identifier reader 110 or as retrieved from the at least one memory 124 based on the identifier read by the identifier reader 110. The at least one processor 126 is also configured to determine a delivery address for the razor cartridge 10 packaged for delivery to the consumer based on the identity of the consumer.

In an embodiment, the system 100 comprises a device 120, such as computer, comprising the at least one memory 124 and the at least one processor 126. The at least one processor 126 and the at least one memory 124 are interconnected to each other to enable normal software execution. An input and output (I/O) unit 122 is preferably connected to the at least one processor 126 and/or the at least one memory 124 to enable communication with external devices, and in particular reception of identifier data as read by eh identifier reader 110. The I/O unit 122 could represent a transmitter and receiver, or transceiver, configured to conduct wireless communication. Alternatively, or in addition, the I/O unit 122 could be configured to conduct wired communication and may then, for instance, comprise one or more input and/or output ports.

The term processor should be interpreted in a general sense as any circuitry, system or device capable of executing program code or computer program instructions to perform a particular processing, determining or computing task. The at least one processor 126 is, thus, configured to perform, when executing program instructions, such as a computer program, well-defined processing tasks such as those described herein.

The at least one processor 126 does not have to be dedicated to only execute the above-described steps, functions, procedure and/or blocks, but may also execute other tasks.

The at least one memory 124 may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The program instructions may, thus, be loaded into an operating memory 124 of the computer 120 for execution by the at least one processor 126 thereof.

In an embodiment, the re-coating device 160 is configured to re-coat the at least a portion of the at least one razor blade 20, 22, 24 with a PTFE coating.

The cleaning and re-coating devices 140, 160 of the system 100 could be implemented as described in the foregoing.

In an embodiment, the razor cartridge 10 is contained in a dispenser 30 comprising multiple razor cartridges 10A, 10B, 10C received from the consumer. In such an embodiment, the at least one memory 124 stores program instructions executable by the at least one processor 126 to verify that the multiple razor cartridges 10A, 10B, 10C are associated with the same consumer identifier.

In a particular embodiment, each razor cartridge 10A, 10B, 10C comprises a consumer identifier 15 or a respective cartridge identifier 15 in turn associated with a consumer identifier. In such a particular embodiment, the at least one memory 124 stores program instructions executable by the at least one processor 126 to verify that the multiple razor cartridges 10A, 10B, 10C comprise the same consumer identifier 15 or that the respective cartridge identifiers 15 of the multiple razor cartridges 10A, 10B, 10C are associated with the same consumer identifier.

In an embodiment, the system 100 further comprises a sharpening device 150 configured re-sharpen the at least one razor blade 20, 22, 24.

The re-sharpening device 150 of the system 100 could be implemented as described in the foregoing.

In an embodiment, the razor cartridge 10 is contained in a dispenser 30 comprising multiple razor cartridges 10A, 10B, 10C received from the consumer. In this embodiment, the at least one memory 124 stores program instructions executable by the at least one processor 126 to verify a quality of the multiple razor cartridges 10A, 10B, 10C and identify any razor cartridge as depleted and unsuitable for refurbishment. The at least one processor 126 is also configured to associate a new razor cartridge replacing the identified razor cartridge with the consumer identifier.

The quality verification could be done by a camera (not shown) taking a picture or video of the razor cartridges 10A, 10B, 10C. The picture or video could then be analyzed by the at least one processor 126 to detect any razor cartridge that is deemed as depleted and unsuitable for refurbishment. Alternatively, a user of the system could visually inspect razor cartridges 10A, 10B, 10C and then, if depleted razor cartridge is found, scan any identifier 15, 21, 23, 23, 25 provided on the depleted razor cartridge 10 using the identifier reader 110. The at least one processor 126 is thereby informed of an identifier 15, 21, 23, 25 of the depleted razor cartridge 10.

In either case, the at least one processor 126 preferably updated the consumer register stored in the at least one memory 124 by removing the depleted razor cartridge from the razor cartridges associated with the consumer. Furthermore, the at least one processor 126 preferably updates the consumer register with the new razor cartridge replacing the depleted razor cartridge. This update may, for instance, be adding the cartridge identifier 15 and/or blade identifiers 21, 23, 25 of the new razor cartridge 10 to the list of such identifiers associated with the consumer and his or her consumer identifier in the consumer register.

In an embodiment, the system 100 comprises a dismantling device 130 configured to dismantle the at least one razor blade 20, 22, 24 from the razor cartridge 10 and a re-assembling device 170. In such an embodiment, the cleaning device 140 is configure to clean the at least one raze blade 20, 22, 24 dismantled from the razor cartridge 10 and the re-coating device 160 is configured to re-coat the at least a portion of the at least one razor blade 20, 22, 24 dismantled from the razor cartridge 10. The re-assembling device 170 is configured to re-assemble the at least one razor blade 20, 22, 24 onto the razor cartridge 10 or onto a new razor cartridge.

In an embodiment, the razor cartridge 10 comprises the consumer identifier 15 or a cartridge identifier in turn associated with the consumer identifier. In addition, the at least one razor blade 20, 22, 24 of the razor cartridge 10 comprises the consumer identifier 21, 23, 25 or a respective blade identifier 21, 23, 25 in turn associated with the consumer identifier. In such an embodiment, the at least one memory 124 stores program instructions executable by the at least one processor 126 to identify the razor cartridge 10 based on the consumer identifier 15 or cartridge identifier 15 comprised in the razor cartridge 10 and identify the at least one razor blade 20, 22, 24 based on the consumer identifier 21, 23, 25 or the respective blade identifier 21, 23, 25 comprised in the at least one razor blade 20, 22, 24. The re-assembling device is then configured to re-assemble the at least one identified razor blade 20, 22, 24 onto the identified razor cartridge 10.

In a particular embodiment, the at least one memory 124 stores program instructions executable by the at least one processor 126 to identify the at least one razor blade 20, 22, 24 as comprising a) the same consumer identifier 21, 23, 25 ai) as comprised in the identified razor cartridge 10 or aii) as associated with the cartridge identifier 15 as comprised in the identified razor cartridge 10 or b) respective blade identifiers 21, 23, 25 associated with the same consumer identifier 15 bi) as comprised in the identified razor cartridge 10 or bii) as associated with the cartridge identifier 15 as comprised in the identified razor cartridge 10.

In an embodiment, the re-assembling device 170 is configured to re-assemble the at least one razor blade 20, 22, 24 onto a new razor cartridge. In such an embodiment, the at least one memory 124 stores program instructions executable by the at least one processor 126 to associate the new razor cartridge with the consumer identifier.

In an embodiment, the at least one memory 124 stores program instructions executable by the at least one processor 126 to add the consumer identifier to the new razor cartridge.

In an embodiment, the at least one memory 124 stores program instructions executable by the at least one processor 126 to associate a cartridge identifier 15 comprised in the new razor cartridge with the consumer identifier.

In an embodiment, the razor cartridge 10 comprises multiple razor blades 20, 22, 24. Each razor blade 20, 22, 24 of the multiple razor blades 20, 22, 24 comprises the consumer identifier or a respective blade identifier in turn associated with the consumer identifier.

In an embodiment, the at least one memory 124 stores program instructions executable by the at least one processor 126 to verify that each razor blade 20, 22, 24 of the multiple razor blades 20, 22, 24 comprises the same consumer identifier 21, 23, 25 or that the respective blade identifiers 21, 23, 25 of the multiple razor blades 20, 22, 24 are associated with the same consumer identifier.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method for refurbishment of razor cartridges, the method comprises:
determining an identity of a consumer based on a consumer identifier associated with a razor cartridge comprising at least one razor blade and received from the consumer;
cleaning the at least one razor blade;
re-coating at least a portion of the at least one razor blade;
verifying a quality of the razor cartridge following cleaning and re-coating;
packaging the razor cartridge for delivery to the consumer; and
determining a delivery address for the packaged razor cartridge based on the identity of the consumer as determined based on the consumer identifier associated with the razor cartridge.

2. The method according to claim 1, wherein re-coating comprises re-coating the at least a portion of the at least one razor blade with a polytetrafluoroethylene (PTFE) coating.

3. The method according to claim 1, further comprising
receiving a dispenser comprising multiple razor cartridges from the consumer; and
verifying that the multiple razor cartridges are associated with the same consumer identifier.

4. The method according to claim 3, wherein
each razor cartridge comprises a consumer identifier or a respective cartridge identifier in turn associated with a consumer identifier; and
verifying that the multiple razor cartridges comprises verifying that the multiple razor cartridges comprise the same consumer identifier or that the respective cartridge identifiers of the multiple razor cartridges are associated with the same consumer identifier.

5. The method according to claim 1, further comprising re-sharpening the at least one razor blade.

6. The method according to claim 1, further comprising:
receiving a dispenser comprising multiple razor cartridges from the consumer;
verifying a quality of the multiple razor cartridges;
replacing any razor cartridge with a new razor cartridge if the quality verification identifies the razor cartridge as depleted and unsuitable for refurbishment; and
associating the new razor cartridge with the consumer identifier.

7. The method according to claim 1, further comprising dismantling the at least one razor blade from the razor cartridge, wherein
cleaning comprises cleaning the at least one raze blade dismantled from the razor cartridge; and
re-coating comprises re-coating the at least a portion of the at least one razor blade dismantled from the razor cartridge, the method further comprising re-assembling the at least one razor blade onto the razor cartridge or onto a new razor cartridge.

8. The method according to claim 7, wherein
the razor cartridge comprises the consumer identifier or a cartridge identifier in turn associated with the consumer identifier;
the at least one razor blade of the razor cartridge comprises the consumer identifier or a respective blade identifier in turn associated with the consumer identifier; and
re-assembling comprises:
identifying the razor cartridge based on the consumer identifier or cartridge identifier comprised in the razor cartridge;
identifying the at least one razor blade based on the consumer identifier or the respective blade identifier comprised in the at least one razor blade; and
re-assembling the at least one identified razor blade onto the identified razor cartridge.

9. The method according to claim 8, wherein identifying the at least one razor blade comprises identifying the at least one razor blade as comprising a) the same consumer identifier ai) as comprised in the identified razor cartridge or aii) as associated with the cartridge identifier as comprised in the identified razor cartridge or b) a respective blade identifier associated with the same consumer identifier bi) as comprised in the identified razor cartridge or bii) as associated with the cartridge identifier as comprised in the identified razor cartridge.

10. The method according to claim 7, wherein re-assembling comprises re-assembling the at least one razor blade onto a new razor cartridge, the method further comprising:
associating the new razor cartridge with the consumer identifier.

11. The method according to claim 10, wherein associating comprises adding the consumer identifier to the new razor cartridge.

12. The method according to claim 10, wherein associating comprises associating a cartridge identifier comprised in the new razor cartridge with the consumer identifier.

13. The method according to claim 1, wherein
the razor cartridge comprises multiple razor blades; and
each razor blade of the multiple razor blades comprises the consumer identifier or a respective blade identifier in turn associated with the consumer identifier.

14. The method according to claim 13, wherein verifying the quality comprises verifying that each razor blade of the multiple razor blades comprises the same consumer identifier or that the respective blade identifiers of the multiple razor blades are associated with the same consumer identifier.

15. A system for refurbishment of razor cartridges, the system comprises:
an identifier reader configured to read an identifier associated with a razor cartridge comprising at least one razor blade and received from the consumer;
a cleaning device configured to clean the at least one razor blade;
a re-coating device configured re-coat at least a portion of the at least one razor blade;
at least one processor;
at least one memory coupled to the at least one processor and the identifier reader, wherein the memory stores program instructions executable by the at least one processor to
determine an identity of a consumer from which the razor cartridge is received based on a consumer identifier as read by the identifier reader or as retrieved from the at least one memory based on the identifier read by the identifier reader; and
determine a delivery address for the razor cartridge packaged for delivery to the consumer based on the identity of the consumer.

16. The system according to claim 15, wherein the re-coating device is configured to re-coat the at least a portion of the at least one razor blade with a polytetrafluoroethylene (PTFE) coating.

17. The system according to claim 15, wherein
the razor cartridge is contained in a dispenser comprising multiple razor cartridges received from the consumer; and
the at least one memory stores program instructions executable by the at least one processor to verify that the multiple razor cartridges are associated with the same consumer identifier.

18. The system according to claim 17, wherein
each razor cartridge comprises a consumer identifier or a respective cartridge identifier in turn associated with a consumer identifier; and
the at least one memory stores program instructions executable by the at least one processor to verify that the multiple razor cartridges comprise the same consumer identifier or that the respective cartridge identifiers of the multiple razor cartridges are associated with the same consumer identifier.

19. The system according to claim 15, further comprising a sharpening device configured re-sharpen the at least one razor blade.

20. The system according to claim 15, wherein
the razor cartridge is contained in a dispenser comprising multiple razor cartridges received from the consumer; and
the at least one memory stores program instructions executable by the at least one processor to
verify a quality of the multiple razor cartridges and identify any razor cartridge as depleted and unsuitable for refurbishment;
associate a new razor cartridge replacing the identified razor cartridge with the consumer identifier.

21. The system according to claim 15, further comprising:
a dismantling device configured to dismantle the at least one razor blade from the razor cartridge; and
a re-assembling device, wherein
the cleaning device is configure to clean the at least one raze blade dismantled from the razor cartridge;
the re-coating device is configured to re-coat the at least a portion of the at least one razor blade dismantled from the razor cartridge; and
the re-assembling device is configured to re-assemble the at least one razor blade onto the razor cartridge or onto a new razor cartridge.

22. The system according to claim 21, wherein
the razor cartridge comprises the consumer identifier or a cartridge identifier in turn associated with the consumer identifier;
the at least one razor blade of the cartridge comprises the consumer identifier or a respective blade identifier in turn associated with the consumer identifier;
the at least one memory stores program instructions executable by the at least one processor to
identify the razor cartridge based on the consumer identifier or cartridge identifier comprised in the razor cartridge; and
identify the at least one razor blade based on the consumer identifier or the respective blade identifier comprised in the at least one razor blade; and
the re-assembling device is configured to re-assemble the at least one identified razor blade onto the identified razor cartridge.

23. The system according to claim 22, wherein the at least one memory stores program instructions executable by the at least one processor to identify the at least one razor blade as comprising a) the same consumer identifier ai) as comprised in the identified razor cartridge or aii) as associated with the cartridge identifier as comprised in the identified razor cartridge or b) respective blade identifiers associated with the same consumer identifier bi) as comprised in the identified razor cartridge or bii) as associated with the cartridge identifier as comprised in the identified razor cartridge.

24. The system according to claim 21, wherein
the re-assembling device is configured to re-assemble the at least one razor blade onto a new razor cartridge; and
the at least one memory stores program instructions executable by the at least one processor to associate the new razor cartridge with the consumer identifier.

25. The system according to claim 24, wherein the at least one memory stores program instructions executable by the at least one processor to add the consumer identifier to the new razor cartridge.

26. The system according to claim 24, wherein the at least one memory stores program instructions executable by the at least one processor to associate a cartridge identifier comprised in the new razor cartridge with the consumer identifier.

27. The system according to claim 15, wherein
the razor cartridge comprises multiple razor blades; and
each razor blade of the multiple razor blades comprises the consumer identifier or a respective blade identifier in turn associated with the consumer identifier.

28. The system according to claim 27, wherein the at least one memory stores program instructions executable by the at least one processor to verify that each razor blade of the multiple razor blades comprises the same consumer identifier or that the respective blade identifiers of the multiple razor blades are associated with the same consumer identifier.
